(19) United States
(12) Patent Application Publication
(10) Pub. No.: US 2021/0047104 A1
(43) Pub. Date: Feb. 18, 2021

(54) DISPENSER FOR USE WITH AN ELONGATED EDIBLE CONFECTION

(71) Applicant: FERRARA CANDY COMPANY, Chicago, IL (US)

(72) Inventors: Judy Jonhee Lee, Highwood, IL (US); Emily Novak, Oakbrook Terrace, IL (US); Dave McGranahan, Oakbrook Terrace, IL (US); Thomas McLaughlin, Oakbrook Terrace, IL (US); Jim Nicketta, Oakbrook Terrace, IL (US); Jennifer Serino, Chicago, IL (US)

(21) Appl. No.: 16/993,089

(22) Filed: Aug. 13, 2020

Related U.S. Application Data
(60) Provisional application No. 62/886,127, filed on Aug. 13, 2019.

(51) Int. Cl. B65D 85/60; B65D 51/24; B65D 43/02; B65D 51/26; B65D 47/28; B65D 83/02; A23G 3/54

(52) U.S. Cl. CPC B65D 85/60; B65D 51/24; B65D 43/0233; A23V 2002/00; B65D 47/286; B65D 83/02; A23G 3/54; B65D 51/26

(57) ABSTRACT

A system for dispensing an edible confection includes an elongate edible gummy confection having a first end and a second end. The dispensing system includes a cutting assembly and a housing. The housing includes an inner chamber adapted for storing the edible confection and an outlet adapted to receive the second end of the edible confection. The cutter may be integrated in the housing, or part of a lid for the housing.

### CROSS REFERENCE TO RELATED APPLICATIONS

This application claims the benefit of U.S. Provisional Application No. 62/886,127, filed Aug. 13, 2019. The entirety of the above referenced application is hereby incorporated by reference.

### TECHNICAL FIELD

This disclosure relates to a dispenser system for a consumable product, such as a confectionery product. More specifically, this disclosure is directed to an elongated edible confection and a dispenser for the elongated edible confection. Additionally, this disclosure is directed to an elongated edible confection configured to be wrapped, rolled, folded, coiled, or wound around an axis.

### BACKGROUND

Confectionery products have been molded, extruded, or otherwise shaped into various forms over the years. It is generally known that providing confectionery products in novelty shapes or forms can lead to enhanced marketability of such a product. Packaging for consumable products, in particular, confectionery products, come in all sizes and shapes, and containers depending on the needs and desires of the consumer.

Systems of dispensing rolled candies are known. U.S. Pat. No. 5,133,980 shows a dispenser for a rolled tape-like confectionery product. The dispenser includes a housing configured to allow the end of the confectionery product to pass through a narrow slot in the sidewall covered by a hinged opening. These dispensing systems however, are limited to flat-tape like confectionery products.

Gelled “gummy” confectionery products are widely known chewy candy with a springy, resilient character with varying degrees of firmness. These confectionery products are often made with gelatin or gelatin alternatives, corn syrup and/or sugar and starches. Such candies may include a “sanding” coating to achieve a taste enhancement such as a sweet and tart sensation. For example, Trolli® gummy crawlers are worm-shaped gummy confections available in an assortment of flavors with taste enhancement coatings.

Gummy confectionery products are often sold in plastic packages having a number of identically sized individual gummies. These packages are inconvenient in that they are often too bulky to carry on a person. Moreover, consumers desire to have control over the portion size of their preferred confectionery product, which is not an option with conventional confectionery packaging. Accordingly, a compact dispenser that can be carried on a person and provides the ability to cleanly dispense and selectively portion a confectionery product while storing the remaining confectionery product and keeping it fresh is highly desirable. The aspects of the present disclosure address these as well as other challenges related to dispensing wrapped, rolled, folded, coiled, or wound edible confections.

### BRIEF SUMMARY

The present disclosure is directed to a system for dispensing an elongated edible confection that is both long and thin (having a diameter that is much smaller than the length). In one embodiment, the system comprises an elongated edible confection having a first end and a second end; a housing configured to store and dispense the elongated edible confection, the housing comprising: an inner chamber having sidewalls and a bottom adapted for storing the elongated edible confection when wrapped, rolled, folded, coiled, or wound; an outlet adapted to receive the second end of the elongated edible confection; and a cutting member. In some embodiments, the cutting member is part of a lid assembly configured to couple with the inner chamber of the housing; in some aspects, the cutting member may be present on a sliding member of the lid assembly where the cutting member is configured to cut the second end of the elongated edible confection when the sliding member is slid over the second end of the elongated edible confection. In other embodiments, the lid assembly further comprises a retaining member configured to retain the second end of the elongated edible confection; in some aspects, the retaining member further comprises a retention tab with an arched recess adapted to retain the second end of the elongated edible confection. The retaining member may have several parts, including but not limited to, a retention tab for interacting with the confection and cutting element, a recess for holding the confection and/or prongs to provide further grip on the end of the confection.

In further embodiments, a system for dispensing an elongated edible confection may have a lid assembly further comprising a sliding member that is configured to slide along a horizontal axis; in some aspects, the cutting member is present on the sliding member. The elongated edible confection may be an elongated gummy confection configured to be coiled around an axis. In some embodiments, the elongated gummy confection may be between about 3 feet and 4 feet in length; in other aspects, the elongated gummy confection may be about 40-48 inches in length, about 42-46 inches in length or about 44-45 inches in length.

In a further aspect of the present disclosure, the dispensing system includes a cap or lid and the cutting member is an integrated part of the cap or lid. In other aspects, the cutting member is a part of the housing. The cutting member may cut the elongated edible confection by a variety of mechanisms. In other aspects, the dispensing system also includes a retaining member for retaining a portion of the elongated edible confection after the confection is cut. The retaining member may have several parts, including but not limited to, a retention tab for interacting with the confection and cutting element, a recess for holding the confection and/or prongs to provide further grip on the end of the confection.

In another aspect of the present disclosure, an elongated edible confection is provided, where the confection comprises an elongated gummy confection that is both long and thin and may be configured to be wrapped, rolled, folded, coiled, or wound around an axis. In some aspects, the elongated edible confection may have a length of at least twice its diameter; in other aspects, the ratio of the length of the elongated edible confection to the diameter of the elongated edible confection may be greater than about 100:1; in further embodiments the ratio may be greater than about 150:1, or between about 150:1 to 200:1. In some embodiments, the elongated gummy confection may be treated with sour sanding. In other embodiments, the elongated edible confection may be further configured to be selectively portioned and/or selectively cut by having an indicator of a portion size section. In further aspects, a portion size section may be denoted by a ridge or series of ridges, or by a color and/or texture change at a predetermined length. The elongated edible confection may be at least about 24 inches in length; in some aspects, the elongated edible confection may be between about 3 feet and 4 feet in length. In other aspects, the elongated gummy confection has a round, nearly round, or oval cross-section.

In a further aspect of the present disclosure, a method of dispensing an elongated edible confection from a dispensing system comprising a cutting member and a housing is provided. The method may include (a) determining the length of the elongated edible confection to be dispensed, (b) threading an end of the elongated edible confection through an outlet of the housing at the determined length, and (c) sliding the cutting member over the outlet to selectively cut and dispense the elongate edible confection. In another aspect, the method may further comprise threading an end of the elongate edible confection through a retaining member located in the housing so that the cut end of the edible confection is retained in the retaining member after selectively cutting. In some embodiments, the cutting member comprises at least one edge that can cut the confection.

These features are pointed out with particularity in the claims annexed hereto and forming a part hereof. These and other advantages, aspects and novel features of the present disclosure, as well as details of an illustrated aspect thereof, will be more fully understood from the following description and drawings.

### BRIEF DESCRIPTION OF THE DRAWINGS

The patent or application file contains at least one drawing executed in color. Copies of this patent or patent application publication with color drawings will be provided by the Office upon request and payment of the necessary fee.

Referring now to the drawings wherein like reference numerals and letters indicate corresponding structure throughout the several views:

FIG. 1 is a perspective view of an embodiment of a system for dispensing an elongated edible confection, in accordance with an exemplary aspect of the disclosure.

FIG. 2 is a front partially exploded view of the system for dispensing an elongated edible confection shown in FIG. 1.

FIG. 3 is a perspective view of an elongated edible gummy confection, in accordance with an exemplary aspect of the disclosure.

FIG. 4 is a view of a further embodiment of a system for dispensing an elongated edible confection, in accordance with an exemplary aspect of the disclosure.

FIG. 5 is a view of a further embodiment of a system for dispensing an elongated edible confection, in accordance with an exemplary aspect of the disclosure.

FIG. 6 is a view of a further embodiment of a system for dispensing an elongated edible confection, in accordance with an exemplary aspect of the disclosure

FIG. 7 is a view of a further embodiment of a system for dispensing an elongated edible confection, in accordance with an exemplary aspect of the disclosure.

FIG. 8 is a view of a further embodiment of a system for dispensing an elongated edible confection, in accordance with an exemplary aspect of the disclosure.

FIG. 9 is a view of a further embodiment of a system for dispensing an elongated edible confection, in accordance with an exemplary aspect of the disclosure.

FIGS. 10A-10C are views of a further embodiment of a system for dispensing an elongated edible confection, in accordance with an exemplary aspect of the disclosure. FIG. 10A shows an exemplary dispensing system in its entirety. FIG. 10B shows the exemplary dispensing system of FIG. 10A having the sliding member removed, while FIG. 10C shows the exemplary sliding member (underside).

FIGS. 11A-11C are views of a further embodiment of a system for dispensing an elongated edible confection, in accordance with an exemplary aspect of the disclosure. FIG. 11A shows an exemplary dispensing system in its entirety. FIG. 11B shows the exemplary dispensing system of FIG. 11A having the sliding member removed, while FIG. 11C shows only the exemplary sliding member (underside).

FIG. 12 is a step-by-step procedure for a user experience with a system for dispensing an elongated edible confection, in accordance with an exemplary aspect of the disclosure.

FIGS. 13A-13C are views of three further embodiments of systems for dispensing an elongated edible confection, in accordance with exemplary aspects of the disclosure. Each of FIGS. 13A, 13B, and 13C illustrate a different lid assembly.

### DETAILED DESCRIPTION

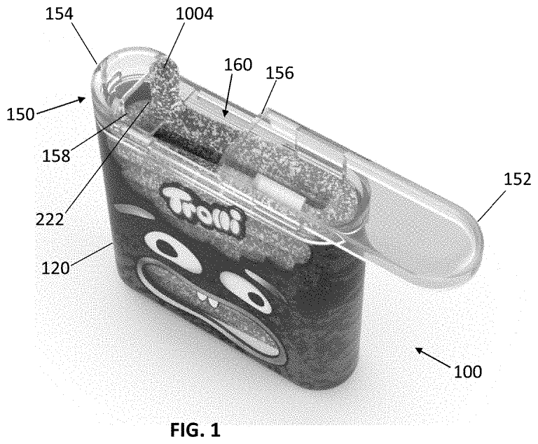

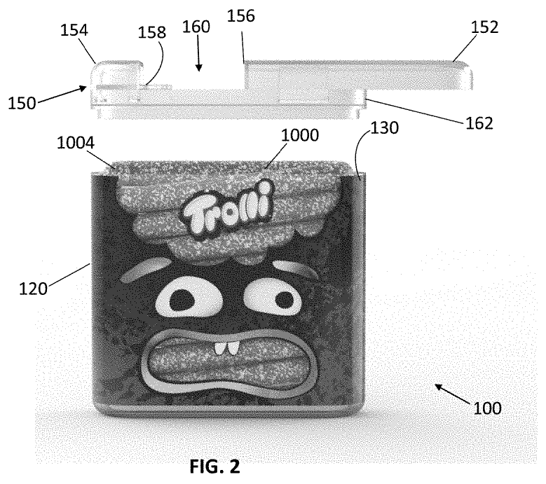

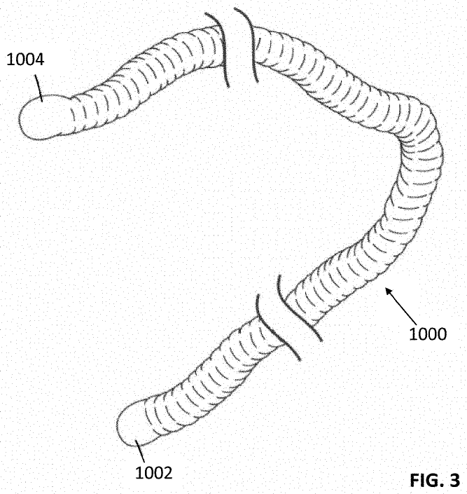

Referring to now to FIGS. 1 and 2, there is shown a dispensing system, generally designated 100, for dispensing an elongated edible confection 1000. As shown in FIG. 3, the elongated edible confection has a first end 1002 and a second end 1004. In one embodiment, the dispensing system has a housing 120 with an inner chamber 130 for storing the elongated edible confection 1000 and an outlet 160 through which a portion at the second end 1004 of the edible confection 1000 may be dispensed. Inner chamber 130 has sidewalls and a bottom and may have a top that can be sealed. The elongated edible confection may be advanced through the outlet 160 by pulling. The dispenser system further comprises a cutting member 156 for selectively cutting the elongated edible confection. In some embodiments, the cutting member 156 is integrated into the lid assembly 150 of the system.

In some embodiments, the housing may have a thin, uniform profile where the lid assembly 150 and the housing 120 are flush with no overhanging lip, while in other embodiments the lid assembly 150 has a small lip that overhangs the housing 120. In some embodiments, the housing may be formed from a plastic material that is moldable into a variety of shapes. Suitable plastics include, but are not limited to, polyethylene terephthalate (PETE or PET), high-density polyethylene (HDPE), polyvinyl chloride (PVC), low-density polyethylene (LDPE), polypropylene (PP), polystyrene or styrofoam (PS), polycarbonate, polylactide, acrylic, acrylonitrile butadiene, styrene, fiberglass, and nylon. In some embodiments, the housing may be molded into the general shape of a rectangle, which may have rounded edges and/or curved corners. In other embodiments, the housing may be molded into shapes including, but not limited to, the shape of a triangle, a cylinder, a sphere, a square, and an annular or elliptical shape, any of which may have rounded edges and/or curved corners; or other shapes.

In some embodiments, the dispensing system may have a cap or lid integrated into the housing. In other embodiments, the dispensing system may further comprise a separate cap or a lid that closes or seals the housing. In some embodiments, the lid fits flush within the inner chamber of the housing providing a uniform profile. In other embodiments, the cap overlaps the housing of the dispensing system (thus creating a lip or raised edge), and/or the cap affixes to the housing through a threaded connection, a frictional connection, or a hinged connection. In some embodiments, the cutter may be integrated into the cap or lid.

In some embodiments, the outlet of the dispensing system through which the elongated edible confection is dispensed may be located in the cap or lid. In some embodiments, the outlet may be located in the top of the housing. In some embodiments, the outlet may be located in the sidewall of the housing. In some embodiments, the outlet may be formed when the housing is coupled with the lid. In some embodiments, the outlet may be a slot. In other embodiments, the outlet may be similar in diameter to the edible confection. In further embodiments, the outlet is serrated which allows for the outlet to serve as a holder for the end of the elongated edible confection (due to interaction with the serrated edges).

In some embodiments, cutting members such as thin, angled and/or sharp edges may be used. In further embodiments, the cutting member is integrated into the lid assembly of the system; in some aspects, the cutting member may be a thin, angled and/or sharp edge that is a part of the lid assembly. In other embodiments, a cutting member is integrated into the housing, including, but not limited to having an outlet which may be sharp, serrated and/or otherwise configured for selectively cutting and/or tearing the elongated edible confection. In further embodiments, the elongated edible confection is cut by the user biting and/or tearing of the desired portion. In embodiments where the elongated edible confection is cut by the user biting and/or tearing, the outlet and/or lid assembly may be configured to retain the second end of the elongated edible confection, such as by having serrations that serve as a holder for the end of the elongated edible confection.

In some embodiments, the elongated edible confection may be wrapped, rolled, folded, coiled, or wound within the inner chamber 130. In other embodiments, the elongated edible confection may be folded within the inner chamber. In other embodiments, the elongated edible confection may be wrapped around a bobbin or paddle located within the inner chamber. In a further embodiment, the elongated edible confection may be wound, rolled, or otherwise organized to fit in the inner chamber neatly without tangling. This allows for the elongated edible confection to be removed from the dispensing system in a controlled way by the user.

The elongated edible confection may be cut by the consumer biting the edible confection. In some embodiments, the cutting allows for the elongated edible confection to be selectively portioned. Biting is one way that the elongated edible confection may be cut; however, other methods may also be employed, such as integrating a way to cut the confection into the package itself. In preferred embodiments, the edible confection is portioned by selectively cutting the edible confection 1000 with a cutting member. Using a cutting member is more sanitary than biting and allows for greater control over portion size. In some embodiments, the cutting member has a thin, angled and/or sharp edge without serrations, while in other embodiments, the cutting member has a serrated edge. In other embodiments, the cutter is designed to couple with the retaining member to form a lid that is flush with the housing.

Referring to FIGS. 1 and 2, in one embodiment the dispensing system 100 has a lid assembly 150 configured to fit within the housing 120 forming a uniform profile. The lid assembly has a sliding member 152 and a bottom portion 162 containing a retaining member 154. The sliding member 152 has a cutting member 156 for selectively cutting a portion at the second end 1004 of the edible confection 1000. The bottom portion 162 has a retaining member 154 and a retention tab 158 with an arched recess 222 through which the second end 1004 of the edible confection 1000 is threaded. The sliding member 152 is configured to slide along a horizontal axis and couple with retaining member 154 to form a closed lid when coupled. The sliding member 152 further comprises cutting member 156 configured to interact with the retention tab 158 to selectively cut a portion of the edible confection 1000 so that a cut end portion of the edible confection 1000 still in the dispenser 100 is retained in the retaining member 154 and thus is ready for the next portion of the confection to be removed and cut. The cutting member 156 is angled to provide the necessary sharpness to cut the confection.

The lid assembly 150 has a sliding member 152 and a bottom portion 162. The bottom portion 162 of the lid assembly 150 is partially covered by the sliding member 152 when the system is closed. In some embodiments, the sliding member 152 is configured to slide along an axis and couple with retaining member 154 to form a closed lid when coupled, where the sliding member 152 is held closed (e.g., by a click or snap closure) to keep the confection sanitary and/or fresh. In further embodiments, the closure between the sliding member 152 and the retaining member 154 forms a seal.

Referring to FIG. 3, the elongated edible confection 1000 may be an elongate rope-like confection. In an embodiment, the edible confection 1000 is an elongated gummy confection having a diameter and length, such as a gummy worm. In some embodiments, the ratio of the length of the elongated edible confection 1000 to the diameter of the elongated edible confection is at least 10:1. In other embodiments, the ratio of the length to the diameter is greater than about 10:1, greater than about 15:1, greater than about 20:1, greater than about 30:1, greater than about 40:1, greater than about 50:1, greater than about 100:1, greater than about 150:1, greater than about 200:1, or greater than about 250:1. In some embodiments, the elongated gummy confection may be at least about 2 feet (24 inches; 61 cm) long or longer. In further embodiments, the elongated gummy confection may be at least about 3 feet (36 inches; 91 cm) long or longer, at least about 4 feet (48 inches; 122 cm), or between about 3 feet and 4 feet (between about 91 cm and 122 cm). In a preferred embodiment, the elongated gummy confection may be from 40-48 inches (102-122 cm) long and may have a ratio of the length to the diameter between about 150:1 to 200:1. In some embodiments, the elongated gummy confection has a round, nearly round, or oval cross-section.

In some embodiments, the elongated edible confection is round or nearly round in cross-section and the diameter of the elongated edible confection is at least 2 mm, but less than 10 mm. In one embodiment, the edible confection has a diameter of about 7 mm and a length of about 2 feet (61 cm). In another embodiment, the edible confection 1000 has a diameter of about 7 mm and a length of about 3-4 feet (91-122 cm). In other embodiments, the elongated edible confection may be about 40-48 inches in length, about 42-46 inches in length or about 44-45 inches in length In a further embodiment, the edible confection 1000 has a diameter of about 7 mm and a length of about 40-48 inches (102-122 cm), giving a ratio of length to diameter ratio of about 146:1 to 174:1. In other embodiments, the elongated edible confection is oval in cross-section, having a width and height each of at least 2 mm, but less than 15 mm. In one embodiment, the elongated edible confection may have a width of about 5-15 mm, about 8-12 mm or about 11-12 mm. In another embodiment, the elongated edible confection may have a height of about 5-12 mm, about 8-12 mm or about 9-10 mm. These dimensions allow for the elongated edible confection to be wrapped, rolled, folded, coiled, or wound and then placed into a container that is small enough to be handheld.

As discussed above, the elongated edible confection 1000 may be a gummy worm. The composition may be similar to the composition of Trolli® crawlers, but other compositions such as in fruit snacks or Black Forest® or other gummies are also foreseen. In some embodiments, the edible confection may be colored and/or flavored, and further coated with a taste-enhancing composition (“sanding”). In some embodiments, the edible confection may have a plurality of sections, each section having a different color and/or flavor. In other embodiments, the edible confection may have a plurality of sections, each section having a different taste enhancement coating. In some embodiments, the elongated edible confection has sections configured to be selectively portioned and/or selectively cut by having an indicator of a portion size section. The portion size section may be denoted by a ridge or series of ridges, or by a color and/or texture change at a predetermined length. In some aspects, the portion size sections are marked, allowing a user to cut regular increments such as 1 in, 2 in, 5 in, etc.

The confection elements may be coated with “sour sanding” to provide sweet and tart taste enhancements to the consumer, or the confection may be an “oiled” type gummy. Oiled gummies are created by applying an oil or other polishing agent layer to the outside of the gummy in the final stages of processing. This gives a shiny appearance to the outside of the gummy and is used to prevent sticking between pieces. The oiling process may be automated in an oiling drum. Sanded gummies can be sweet or sour; many sanded gummies use “sour sanding,” which is a mixture of sugar plus a tart/sour agent such as tartaric or citric acid. These are created by applying steam to a finished gummy to add tackiness, then adding the sanding coating. The sanding process may also be automated. For elongated edible confections, sanding or oiling may help to keep the confection from sticking to itself when wrapped, rolled, folded, coiled, wound, or otherwise organized and allows for easier removal of the confection from the package. In a preferred embodiment, the elongated edible confection is treated with sour sanding and has a round, or nearly round, cross-section.

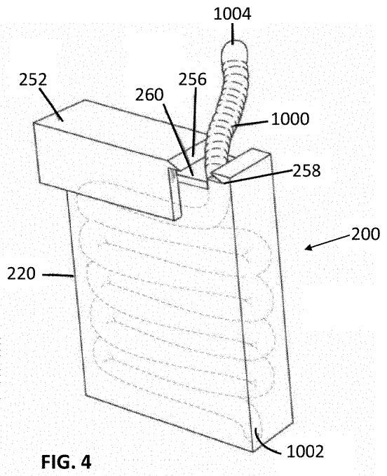

Referring to FIG. 4, there is shown a second embodiment of a dispensing system, generally designated 200. The dispensing system 200 includes a generally rectangular housing 220 with a greater height than width or depth. The housing 220 forms an inner chamber 230 configured to store the edible confection 1000 in a folded or coiled manner. The housing 220 forms an outlet 260 through which the edible confection is dispensed. The edible confection may be advanced through the outlet 260 by pulling on the edible confection. Also contemplated is a system that advances the edible confection through outlet 260 by using a pushing or twisting motion. A sliding member 252 includes a cutter 256 configured to selectively cut a portion of the edible confection 1000 so that an end portion of the edible confection still in the dispenser 100 is retained in the housing 220. In one embodiment, an angled cutting member 256 selectively cuts a portion of the edible confection 1000 at the second end 1004. In some aspects, the cutting member fits in a complementary recess 258. In some embodiments, the edible confection 1000 may be folded or coiled within the inner chamber, with the first end 1002 at the bottom of the housing 220.

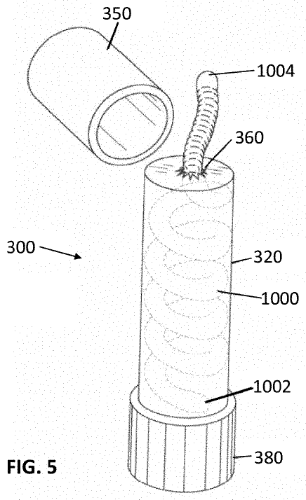

Referring to FIG. 5, there is shown a third embodiment of a dispensing system, generally designated 300. The dispenser system 300 has a cylindrical housing 320. The dispensing system 300 has a removable cap 350 mounting to the top of the housing 320. The dispensing system has a serrated outlet 360. The dispensing system 300 has an advancement member 380 that advances the edible confection through serrated outlet 360 by using a pushing or twisting motion. In one embodiment, the serrated outlet 360 allows for a portion of the edible confection 1000 to be removed at the second end 1004. In another embodiment, the serrated outlet 360 retains the second end 1004 of the elongated edible confection after the desired portion is removed; in one aspect, the serrated outlet 360 serves as a holder for the end of the elongated edible confection (due to interaction with the serrated edges) after a user cuts the confection by biting and/or tearing. In further embodiments, the edible confection 1000 may be cut by the serrated outlet 360 by tearing. In some embodiments, the edible confection 1000 may be coiled within the inner chamber, with the first end 1002 at the bottom of the housing 320.

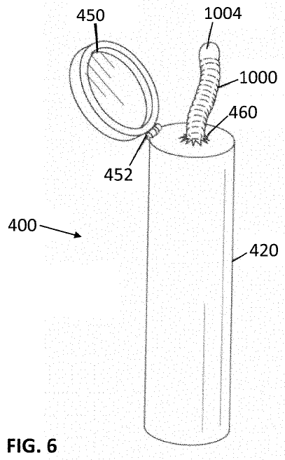

Referring to FIG. 6, there is shown a fourth embodiment of a dispensing system, generally designated 400. The dispensing system 400 has a cylindrical housing 420 with an inner chamber configured to store the edible confection 1000. The dispensing system has a lid 450 with hinged connection 452. The dispensing system 400 has a serrated outlet 460. The edible confection may be advanced through the serrated outlet 460 by pulling on the edible confection. Also contemplated is a system that advances the edible confection through outlet 460 by using a pushing or twisting motion. In one embodiment, the serrated outlet 460 allows for a portion of the edible confection 1000 to be removed at the second end 1004. In another embodiment, the serrated outlet 460 retains the second end 1004 of the elongated edible confection after the desired portion is removed; in one aspect, the serrated outlet 460 serves as a holder for the end of the elongated edible confection (due to interaction with the serrated edges) after a user cuts the confection by biting and/or tearing. In a further embodiment, the edible confection 1000 may be cut by the serrated outlet 460 by tearing.

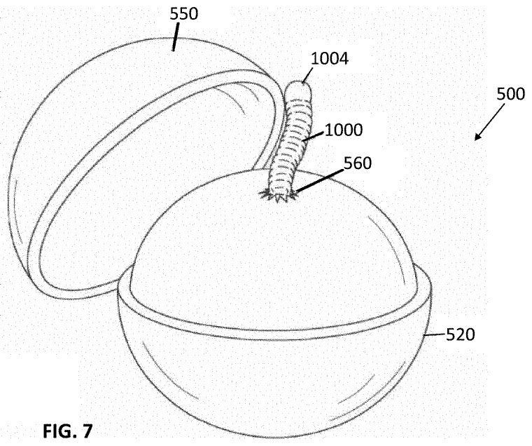

Referring to FIG. 7, there is shown a fifth embodiment of a dispensing system, generally designated 500. The dispensing system 500 has a housing 520 that is spherical in shape. The dispensing system has a detachable removable hemi-spherical cap 550. The housing 520 has an inner chamber configured to store the edible confection. The dispensing system 500 has a serrated outlet 560. The edible confection may be advanced through the serrated outlet 560 by pulling. In one embodiment, the serrated outlet 560 allows for a portion of the edible confection 1000 to be removed at the second end 1004. In another embodiment, the serrated outlet 560 retains the second end 1004 of the elongated edible confection after the desired portion is removed; in one aspect, the serrated outlet 560 serves as a holder for the end of the elongated edible confection (due to interaction with the serrated edges) after a user cuts the confection by biting and/or tearing. In further embodiments, the edible confection 1000 may be cut by the serrated outlet 560 by tearing.

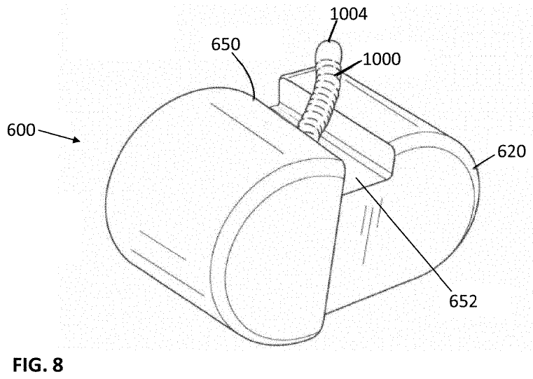

Referring to FIG. 8, there is shown a sixth embodiment of a dispensing system, generally designated 600. The dispensing system 600 has a housing 620 with an oval or elliptical shape. The dispensing system 600 has an outlet (not shown) through which the edible confection is advanced, and a sliding member 650 adapted to selectively cut a portion at the second end 1004 of the edible confection 1000. The sliding member is matched by a complementary recess 652 in the housing 620. The edible confection may be advanced through the outlet by pulling. In one embodiment, the sliding member 650 allows for a portion of the edible confection 1000 to be removed at the second end 1004.

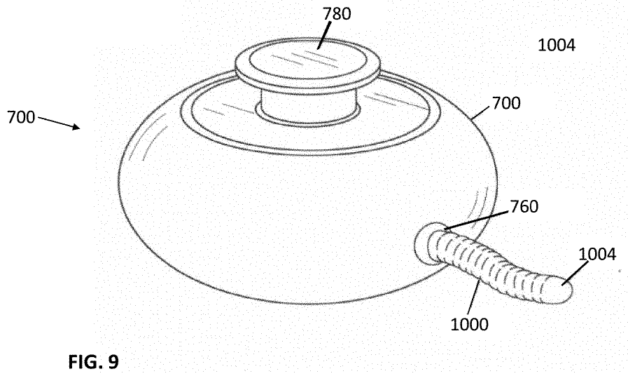

Referring to FIG. 9, there is shown a seventh embodiment of a dispensing system, generally designated 700. The dispensing system 700 has a housing 720 with a round and/or oval cross-section. The housing 720 forms an annular inner chamber. The annular inner chamber may be configured to store the elongated edible confection 1000 in a coiled manner. The dispensing system 700 has an outlet 760 in the sidewall of the housing 720. The dispensing system 700 has push button 780 that serves to both advance the confection (by turning or twisting) and is also is coupled to a cutting member that selectively cuts the edible confection 1000 when the push button 780 is pressed.

The housing may be opaque, translucent, transparent, or a combination thereof. In some aspects, the housing is configured to have an opaque section and a transparent section. The housing and/or lid may be configured to receive a label or decorative sticker. In some aspects, the housing and/or lid have ornamentation, including, but not limited to, figures, characters, animals, dots, stripes, lines, or chevrons, which may be raised and/or in relief.

Also provided in the present disclosure are methods of dispensing an elongated edible confection 1000. The method comprises loading an elongated gummy confection, having a first end 1002 and a second end 1004 into the inner chamber of a housing. The elongated gummy confection is loaded by wrapping, rolling, folding, coiling, or winding. In some embodiments, the method further comprises threading the second end 1004 of the coiled gummy 100 through an outlet in the housing. In further embodiments, the method further comprises selectively cutting a portion at the second end of the coiled gummy with a cutter.

In other embodiments, the method of dispensing an elongated edible confection comprises loading the edible confection 1000 into the inner chamber of the housing, inserting the lid assembly into the inner chamber of the housing to form an outlet that goes through the lid assembly, threading the second end 1004 of the edible confection through the outlet and through a retaining member located on the lid assembly, selectively cutting a portion at the second end of the edible confection 1000 so that a portion of the edible confection is retained in the retaining member. In some embodiments, the edible confection 1000 is selectively cut by sliding the cutting member along a horizontal axis perpendicular to the second end of the edible confection. In some aspects, the cutting member fits into or along a complementary recess.

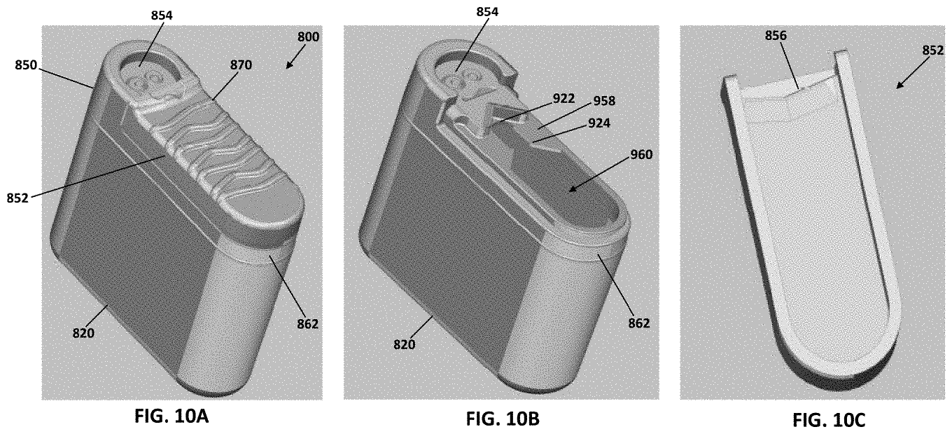

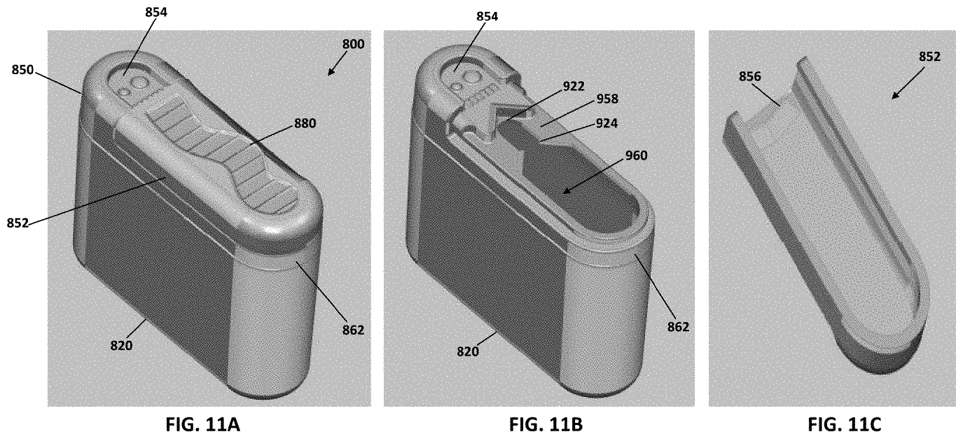

FIGS. 10 and 11 show two further embodiments of the dispensing system 800. In FIGS. 10A and 11A the whole dispensing system 800 is shown, having a multi-part lid assembly 850 configured to fit on the housing 820. The housing 820 holds the elongated edible confection. The lid assembly 850 has a sliding member 852 and a bottom portion 862. The bottom portion 862 of the lid assembly 850 is partially covered by the sliding member 852 when the system is closed. A retaining member 854 is part of the bottom portion 862 of the lid assembly and is configured to couple with sliding member 852 to form a closed lid when coupled. In FIG. 10A, the sliding member 852 has raised ridges 870 as ornamentation that also provides grip for better opening and closing of the dispensing system. In FIG. 11A, the sliding member 852 has recessed ridges 880 in the shape of a worm as ornamentation that also provides grip for better opening of the dispensing system.

FIGS. 10B and 11B illustrate the bottom portion 856 of the lid assembly with the sliding member removed. The outlet 960 through which a portion at the end of the edible confection may be dispensed is shown. The retaining member 854 has a retention tab 958 with an arched recess 922 through which the elongated edible confection can be threaded. Two prongs 924 hold the elongated edible confection in place so that it remains ready to be dispensed. The retention tab 958, arched recess 922, and prongs 924 allow a cut end portion of the elongated edible confection to be retained in the retaining member 854 of the dispensing system 800 and to be ready for the user to remove and cut a further portion of the confection.

FIGS. 10C and 11C illustrate the underside of sliding member 852. The sliding member 852 engages with the bottom portion of the lid assembly to form a closed lid when coupled (as shown in FIGS. 10A and 11A). The sliding member 852 further comprises cutting member 856 configured to interact with the retaining member to selectively cut a portion of the edible confection so that a cut end portion of the edible confection still in the dispenser is retained in the retaining member and thus is ready for the next portion of the confection to be removed and cut.

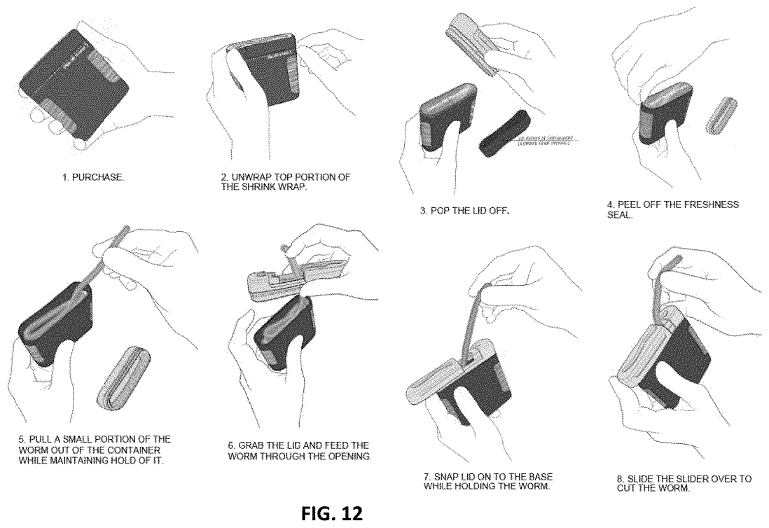

FIG. 12 shows an exemplary user experience for the dispensing system as shown in FIGS. 1, 2, 10, and 11 with the elongated edible confection.

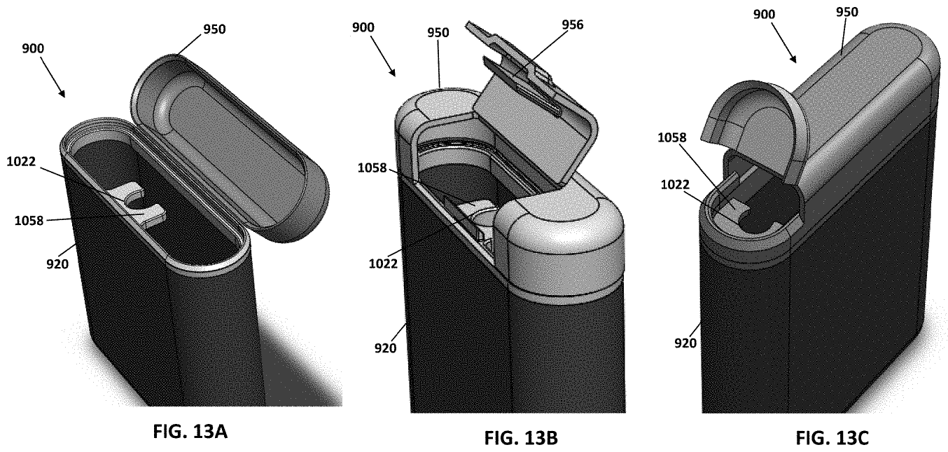

FIGS. 13A, 13B, and 13C show further embodiments of the dispensing system 900 having various lid assemblies 950 configured to fit on the housing 920. The dispensing system 900 is in the form of a rounded off rectangle, with two long sides and two shorter, curved ends. FIG. 13A shows a lid assembly 950 that has a hinged opening that is about the same diameter as the housing 920. The lid assembly 950 has retention tab 1058 with an arched recess 1022 through which the elongated edible confection can be threaded. FIG. 13B shows a lid assembly 950 that has a hinged opening that is smaller than the housing 920. The hinged opening is in the middle of one of the long sides of the dispensing system 900. The lid assembly also includes a separate cutting member 956. The lid assembly 950 has retention tab 1058 with an arched recess 1022 through which the elongated edible confection can be threaded. FIG. 13C shows a lid assembly 950 that has a hinged opening that is smaller than the housing 920. The hinged opening is at one of the shorter curved ends of the dispensing system 900. The lid assembly 950 has retention tab 1058 with an arched recess 1022 through which the elongated edible confection can be threaded.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for dispensing an elongated edible confection, the system comprising:
an elongated edible confection having a first end and a second end; and
a housing configured to store and dispense the elongated edible confection, the housing comprising:
an inner chamber having sidewalls and a bottom adapted for storing the elongated edible confection when wrapped, rolled, folded, coiled, or wound;
an outlet adapted to receive the second end of the elongated edible confection; and
a cutting member.

2. The system of claim 1, wherein said cutting member is part of a lid assembly configured to couple with the inner chamber of the housing.

3. The system of claim 2, wherein said cutting member is present on a sliding member of said lid assembly wherein said cutting member is configured to cut the second end of the elongated edible confection when said sliding member is slid over the second end of the elongated edible confection.

4. The system of claim 2, wherein said lid assembly further comprises a retaining member configured to retain the second end of the elongated edible confection.

5. The system of claim 4, wherein the retaining member further comprises a retention tab with an arched recess adapted to retain the second end of the elongated edible confection.

6. The system of claim 5, wherein the lid assembly further comprises a sliding member that is configured to slide along a horizontal axis.

7. The system of claim 6, wherein said cutting member is present on said sliding member.

8. The system of claim 1, wherein the elongated edible confection comprises an elongated gummy confection configured to be coiled around an axis.

9. The system of claim 1, wherein the elongated edible confection comprises an elongated gummy confection that is between about 3 feet and 4 feet in length.

10. The system of claim 9, wherein the elongated edible confection comprises an elongated gummy confection that is about 40-48 inches in length.

11. An elongated edible confection comprising:
an elongated gummy confection that is both long and thin;
wherein the ratio of the length of the elongated edible confection to the diameter of the elongated edible confection is greater than about 100:1.

12. The elongated edible confection of claim 11, wherein the ratio of the length of the elongated edible confection to the diameter of the elongated edible confection is greater than about 150:1.

13. The elongated edible confection of claim 11, wherein the ratio of the length of the elongated edible confection to the diameter of the elongated edible confection is between about 150:1 to 200:1.

14. The elongated edible confection of claim 11, wherein the elongated gummy confection is treated with sour sanding.

15. The elongated edible confection of claim 11, wherein the elongated edible confection is further configured to be selectively portioned and/or selectively cut by having an indicator of a portion size section.

16. The elongated edible confection of claim 15, where said portion size section is denoted by a ridge or series of ridges, or by a color and/or texture change at a predetermined length.

17. The elongated edible confection of claim 11, wherein the elongated edible confection is at least about 24 inches in length.

18. The elongated edible confection of claim 17, wherein the elongated edible confection is between about 3 feet and 4 feet in length.

19. A method of dispensing an elongated edible confection from a dispensing system comprising a cutting member and a housing, the method comprising:
(a) determining the length of the elongated edible confection to be dispensed;
(b) threading an end of said elongated edible confection through an outlet of said housing at the determined length; and
(c) sliding said cutting member over said outlet to selectively cut and dispense said elongated edible confection.

20. The method of claim 19, wherein the method further comprises:
(d) threading an end of the elongated edible confection through a retaining member located in said housing so that the cut end of the elongated edible confection is retained in the retaining member after selectively cutting.
